(19) United States
(12) Patent Application Publication
(10) Pub. No.: US 2025/0070707 A1
(43) Pub. Date: Feb. 27, 2025

(54) SOLAR ELECTRICAL GENERATOR

(71) Applicant: Solivus Limited, London (GB)

(72) Inventors: Daniel MERUZ, Cambridge (GB); Paul SCOTT, Cambridge (GB)

(21) Appl. No.: 18/826,407

(22) Filed: Sep. 6, 2024

Related U.S. Application Data
(63) Continuation of application No. PCT/GB2023/050551, filed on Mar. 8, 2023.

(30) Foreign Application Priority Data
Mar. 8, 2022 (GB) 2203201.5
Mar. 11, 2022 (GB) 2203418.5

(51) Int. Cl. H02S 20/20

(52) U.S. Cl. CPC H02S 20/20

(57) ABSTRACT

A solar electrical generator comprising an outer wall (1) defining an open top (2) central cavity (4). The outer wall (1) comprises an open frame comprising a plurality of curved members (30, 31, 32) formed with curved channels (34, 35, 36, 37). The members are arranged such that the curved channels (34, 35, 36, 37) on adjacent members face one another. A plurality of flexible solar panels (11) are sized such that a respective solar panel can be slid into place in the frame between adjacent facing curved channels (34, 35, 36, 37) and supported by the adjacent curved channels.

### CROSS-REFERENCE TO RELATED APPLICATIONS

This Application is a Continuation of Application PCT/GB2023/050551 filed on Mar. 8, 2023. Application PCT/GB2023/050551 claims priority from Application 2203418.5 filed on Mar. 11, 2022 in the United Kingdom. Application PCT/GB2023/050551 also claims priority from Application 2203201.5 filed on Mar. 8, 2022 in the United Kingdom. The entire contents of each of the foregoing is herein incorporated by reference.

### BACKGROUND

### Field

The present invention relates to a solar electrical generator.

### Description of the Related Art

In particular, the present invention relates to a development of the solar electrical generator disclosed in our earlier WO2020/039181.

This generator represents a significant departure from conventional solar generators which generally use flat panels of solar cells. Our generator takes a different approach in that it has an outer wall defining a cavity.

Flexible solar fabric is applied to a rigid curved frame. Although not mentioned in WO 2020/039181, the product that we made (known as the Solivus Arc (RTM)) has a frame made of a continuous material to which the flexible solar fabric is attached using an adhesive.

WO 2021/226194 discloses a rotatable solar tower with an airfoil structure. Part of the airfoil structure is made of rigid solar panels supported in straight channels.

CN207368924 discloses a relatively small solar device for attachment to a lamp post. The device has a pair of curved plates to provide support for flexible solar material. Brackets are attached to the inner face of the plates to provide an attachment to the lamp post. The plates have top and bottom flanges to form a positioning area for the solar material.

The present invention is aimed at improving the generator of WO2020/039181.

### SUMMARY

According to the present invention, there is provided a generator according to claim 1.

Instead of providing a continuous frame to which the fabric is adhered, the present invention proposes creating an open frame from a plurality of members with channels into which the solar panels are slotted into place and supported.

This has a number of significant benefits. The amount of material required to create the generator is significantly reduced as there is no longer a need to provide a continuous surface to which the solar panels can be adhered. This reduces the cost and the weight of the generator. Further, in event of damage to an individual solar panel, it can simply be slid out of the frame and replaced by the new one. With the original design, there was no practical way of replacing the damaged solar panel. This design also allows the generator to be upgraded by replacing the panels with more efficient ones as they become available.

The outer wall may support solar panels which face only in a single direction. Alternatively, back to back solar panels could be slid into a single channel. However, preferably, each member has a pair of channels each supporting a respective solar panel in a back to back relationship. This provides a straightforward way of supporting back to back solar panels each in their own channel such that one can easily be removed independently of the other.

The members may extend in any direction such that the supportive solar panels are arranged in an oblique or vertical direction. However, preferably, the members are arranged substantially horizontally. This allows relatively long solar panels to be used as compared to arranging the members in a different orientation.

The members may be sufficiently stiff and they provide the necessary rigidity to the generator. However, preferably, a plurality of vertical support struts extend vertically along the outer wall are provided. These can contribute significantly to the structural integrity of the generator thereby allowing the members themselves to be smaller and lighter. When the solar electrical generator is supporting back to back solar panels, the vertical support struts could be positioned to extend in the gap between the back to back panels such that they are not visible in use.

The generator may be formed as a single continuous outer wall. Preferably, however, the generator further comprises an open gap formed in the outer wall on one side of the cavity as in our earlier WO2020/039181. In this case, the generator further comprises a central solar cell in the cavity having a lower end adjacent to the gap and an upper end on the opposite side of the cavity from the gap, so that the central solar cell faces the gap, the central solar cell comprising a further frame formed of a further plurality of members formed with channels, the further members being arranged such that the channels on adjacent members face one another; and a further plurality of flexible solar panels sized such that a respective further solar panel can be slid into place in the further frame between adjacent channels and is supported by the adjacent channels.

This provides additional generating capacity in the central solar cell which faces the open gap. The central solar cell is again formed of a structure comprising members thereby providing the same benefits of cost/weight and replaceability to the central solar cell.

The central solar cell may be of any shape such as flat or slightly convex. However, it is preferably concave.

The upper end of the central solar cell is preferably connected to the outer wall to create a covered space between the solar cell and the outer wall. This provides a useful space in which to install ancillary equipment. To further enclose this space, side panels may be provided between the outer wall of the central solar cell to create a closed cavity beneath the outer wall and the central solar cell.

The flexible solar panels may be made of any flexible solar material but preferably comprise a thin film organic photo voltaic (OPV) material. The panels are backed with a stiffening material. This may be any flexible material, for example a pvc foam board such as foamex.

The ends of the channels may be left open or may be arranged to be covered another component of the generator. However, preferably, the generator further comprises an end cap removable attached to the ends of the channels of adjacent members to support the end of the solar panel between the adjacent channels. These end caps close off the ends of the channels thereby supporting the ends of the solar panel as well as improving the appearance of the generator and removing the possibility for dirt and moisture to enter via the ends of the channels. The end cap may extend across the end of a single pair of channels, but preferably extend across multiple pairs of channels such that a single end cap can support the ends of a plurality of solar panels thereby reducing the number of components in the generator.

The members and further members may be formed in any suitable way such as being moulded, but are preferably formed as extrusions.

A second aspect of the invention is defined in claim 17. As the upper end of the central solar cell is connected to the outer wall, not only does this optimise the amount of space available for the central solar cell, it also creates a covered space between the solar cell and the outer wall which can usefully accommodate ancillary equipment for the solar electrical generator.

This covered space may have open sides. However, preferably, side panels are provided between the outer wall and the central solar cell to support the central solar cell and create a closed cavity beneath the central solar cell.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

An example of a solar electrical generator will now be described with reference to the accompanying drawings, in which:

FIG. 1 is a front perspective view of the generator;

FIG. 2 is rear perspective view of the generator;

FIG. 3 is schematic cross-section through a median plane of the generator;

FIG. 4A is a cross-section through the top portion of the generator;

FIG. 4B is a cross-section through an intermediate portion of the generator;

FIG. 4C is a cross-section through a lower portion of the generator;

FIG. 5 is a cross-section in a horizontal plane through a back portion of a generator;

FIG. 6 is a cross-section through a front trim of the generator;

FIG. 7 is a cross-section through the side of the central solar cell; and

FIG. 8 is a cross-section through a central part of the central solar cell.

### DETAILED DESCRIPTION

The solar electrical generator comprises an outer wall 1 which is shown as having a partially cylindrical configuration with an open top 2. The gap subtends an angle of between 9° and 30° at the centre of the outer wall 1. The wall defines a cavity 4, the lower end of which is closed by a base 5.

The generator may be scaled to any size, such that it can be used in small scale applications to power individual isolated items such as lights or parking meters. At the other end of the scale it may be used as part of an array on a solar farm. However, the primary intention is for the generator to be used in a domestic dwelling to provide electrical power for homes and/or vehicles.

The outer wall 1 which is made of a frame 6 to which strips of flexible solar material 7 are attached. These are provided on both the inside 8 and the outside 9 faces of the inner wall 1 such that they will generate electricity when the sun is radiating on either side of the outer wall. On the side of the outer wall 1 opposite to the gap 3, is a wall portion 10 which is devoid of solar material as described in greater detail below.

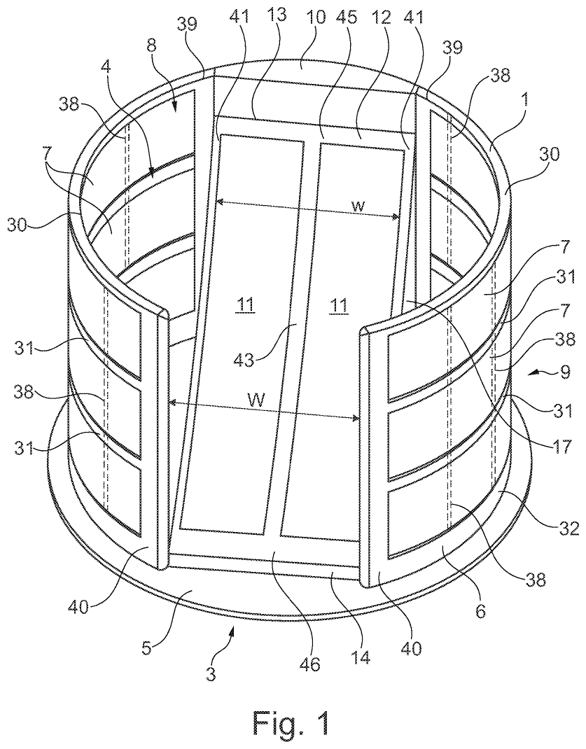

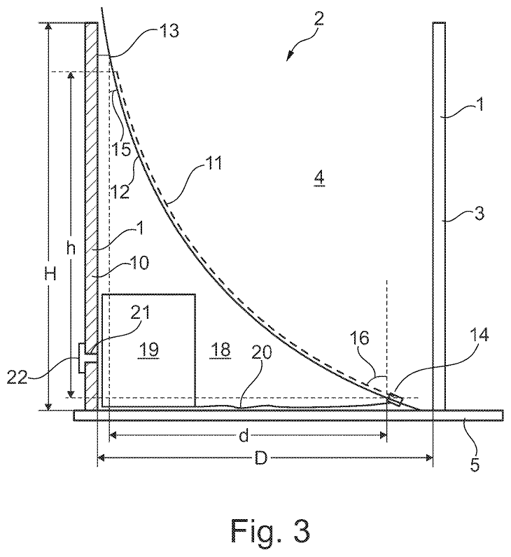

The second solar generating component comprises a concave frame 12 to which strips of flexible solar material forming the central solar cells 11 are attached. The frame 12 has a top end 13 attached to the wall portion 10 and a bottom end 14 attached to the base 5. The part of the central solar cell 11 closest to the gap 3 is the lowermost part of the solar cell 11. The frame 12 has a concave configuration as best shown in FIGS. 1 and 3 which has a radius of curvature which decreases from the top end 13 to the bottom end 14 such that the top part of the frame 12 initially descends relatively steeply before becoming shallower towards the bottom end 14. As will be apparent from FIG. 3, the horizontal depth d of the central solar cells 11 occupies a significant portion of the depth D of the cavity 4 as measured between the wall portion 10 to the gap 3.

Similarly, the central solar cells 11 have a significant vertical height h.

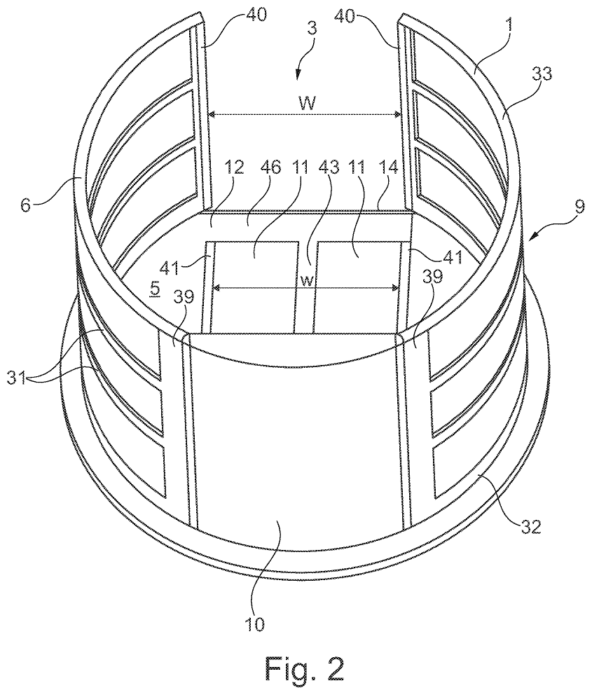

As can best be seen from FIGS. 1 and 2, the width w of the solar cells (between the outermost extremities of the solar cells 11) is approximately the same as the width W of the gap 3.

The generator is mounted with the gap 3 facing the south in the northern hemisphere and north in the southern hemisphere. During the course of the day, the sun will track from right to left as show in FIG. 1 and from left to right as shown in FIG. 2. The sun will track generally on the side of the generator with the gap 3 at various degrees of elevation depending upon the time of year.

With reference to FIG. 1, at the start of the day, the sunlight will be incident on the parts of the flexible solar material 7 facing to the right, either on the inside face 8 or outside face 9 of the outer wall 1. At this time, all or most of the central solar cells 11 will be shaded by the outer wall 1. As the sun rises higher in the sky, more sunlight will be incident on the solar cells 11.

If the sun is directly above the generator, the sunlight will only be incident in the central solar cells 11. However, normally, at midday, when the sun is not directly above the generator, it will be aligned with the gap 3 and frame 12 such that it will be incident on all of the central solar cells 11 as well as a flexible solar material 7 on the outer wall 9 either side of the gap and on the inner wall 8 either side of the wall portion 10.

As the sun progresses further to the left in FIG. 1, it will then be incident on the opposite side of the generator such that it will radiate onto the outside face 9 on the left hand side of the generator and inside face 8 on the right hand side of the generator.

As is best appreciated from FIG. 1, the central solar cells 11 are configured such that as the sun tracks as described above, the shadow cast by the central solar cells 11 onto the flexible solar material 7 is minimised.

As will be appreciated form consideration of FIG. 1, as the sun tracks in this way, the central solar cells 11 are able to absorb a significant portion of the solar radiation in the middle of the day when more of the flexible solar material 7 is in shade. On the other hand, earlier and later in the day, a greater proportion of the solar radiation is absorbed by the flexible solar material 7 than the central solar cells 11.

This ensures that despite the relatively complex geometry as compared to a conventional flat solar panel, the generator is able to generate uniformly throughout the day.

The region behind the frame 12 and in front of the wall portion 10 is closed off by a pair of side panels 17, one of which can be seen in FIG. 1. The other is on the opposite side of the frame 12 and both are shaped to fill the gap between the frame 12 and wall portion 10. This creates a cavity 18 which can be used to house ancillary equipment 19 such as inverters and storage in the form of a fly wheel or battery. This is connected to the central solar cells 11 by a wire 20. A similar connection is provided to the flexible solar panels 7. An electrical output 21 connects the equipment 19 to an external socket 22 which can receive a plug from external equipment to be charged. An access door (not shown) can be provided in the wall portion 10 to allow access to the service of the equipment 19.

Thus, the generator can be provided as a single standalone unit in which all of the ancillary equipment is hidden from view thereby improving the aesthetics of the generator. It is also protected from environment degradation and damage caused by accidental impacts.

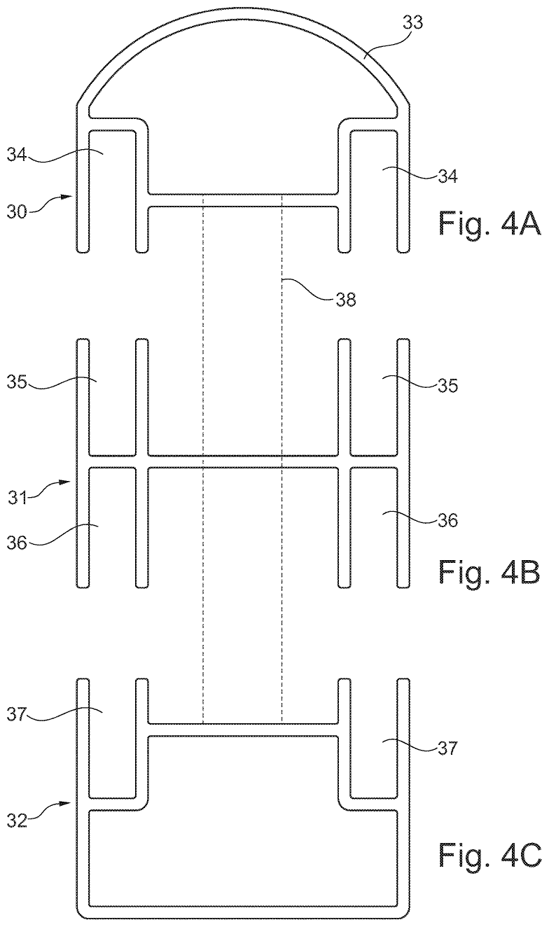

The manner in which the generator is assembled will now be described with reference to FIGS. 4 to 8.

The frame 6 comprises two sides which extend along opposite sides of the cavity 4 and are constructed as a mirror image. In each case, the frame 6 consists of an upper cap 30, a pair of intermediate rails 31 and a base 32. The profiles of these components are shown in FIGS. 4A and 4C. These three Figures are arranged vertically in order as they would appear in the frame. However, with reference to FIG. 1, there would be two intermediate rails 31 where only one is shown in FIG. 4B.

Each of these components are formed as a curved extrusion having the cross section shown in FIGS. 4A and 4C.

The upper cap 30 has a convex upper portion 33 forming the top of the outer wall 1 with a pair of downwardly depending channels 34 which receive the strips of flexible solar material 7. One of the channels 34 receive the strip on the inside face 8 whilst the other receives the strip on the outside face 9. The intermediate rail 31 has a complimentary pair of upwardly facing channels 35 which receive the lower edges of the panels, the upper edges of which are received in the grooves 34.

Each of the intermediate rails 31 are formed with lower, downwardly facing channels 36 which receive the upper edges of the inner and outer flexible solar material 7, the bottom edges of which are received in channels 37 in the base 32.

A number of reinforcing rods 38 extend vertically between the upper cap 30 and base 32 passing through intermediate rails 31 in order to provide rigidity to the outer wall 1. As shown in FIG. 1, there are three such rods for each side of the generator, but more or less can be used as needed. As will be appreciated from FIGS. 4A to 4C, the rods 38 are covered by the flexible solar material 7 in use.

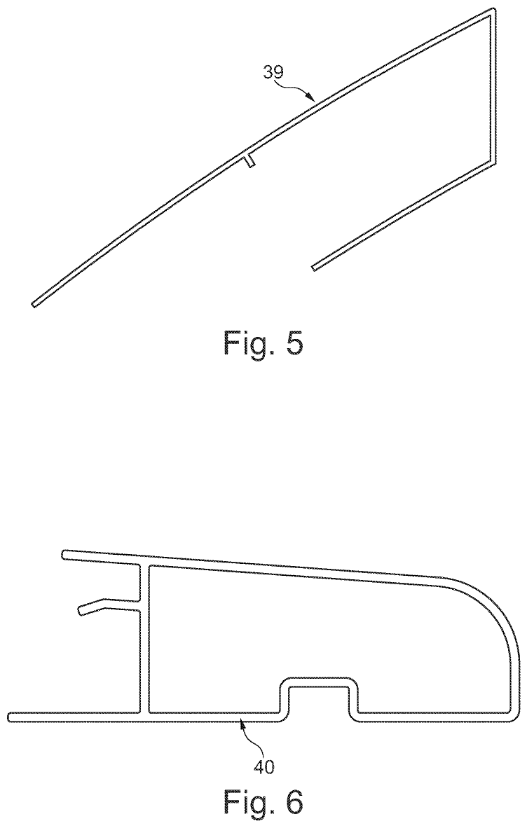

The rear edge of each of the walls 1 terminates in an extruded rear trim 39 as shown in FIG. 5. This receives the rearmost edges of both the inner and outer flexible solar material 7.

Once the cap 30, rails 31 and base 32 are in fitted to the rear trim 39, the cells 11 can be slid into place along the channels 34, 35, 36, 37 until they meet the rear trim 39. In the Figures, each cell 11 extends all the way from the front to the rear trim 39. In practice, two or more cell sections could be used to fill each space, possibly with additional spacers between the sections.

The front of each wall portion 1 terminates in an extruded front trim 40 as shown in FIG. 6 which is fitted in place once the cells 11 are in place. This is shaped to connect with the forward ends of the cap 30, intermediate rails 31 and base 32 as shown in FIG. 1, and supports the forward edge of the inner and outer flexible solar material 7. Either or both of the rear trim 39 and front trim 40 are removable to allow either of the strips of flexible solar material 7 to be slid out of the grooves in which it is retained in which it order that it can be replaced.

The cap 30, rails 31, base 32, rear trim 39 and front trim 40 form an open frame in the sense that the space between them is open and there is no support layer filling the gaps between these parts. This provides a lightweight structure which is also easy transport. The reinforcing rods 38 do not substantially affect the open nature of the frame structure.

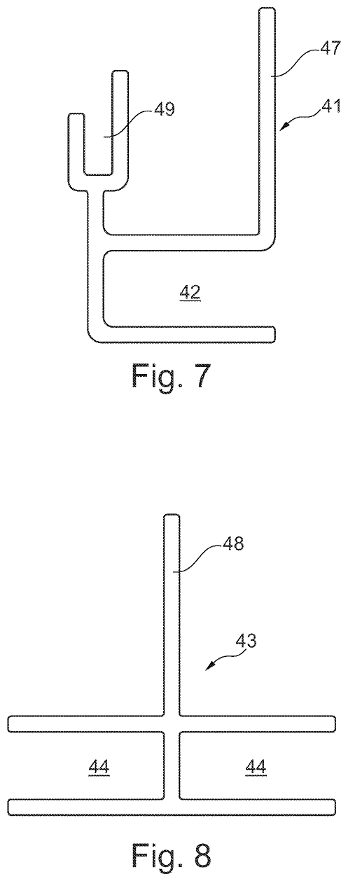

A similar arrangement is provided for the central solar cells 11. In this case, there is an end cap 41 as shown in FIG. 7. The end cap shown in FIG. 7 is suitable for the left hand side of the frame 12 as shown in FIG. 1 and a mirror image (not shown) will be provided on the other side of the frame 12. The end cap 41 has a channel 42, which, in FIG. 7, will receive the left hand side of the left hand solar cell 11. The opposite end of the solar cell 11 is retained in a central cap 43 as shown in FIG. 8. This has a pair of opposed channels 44, one of which receives the right hand edge of the left hand solar cell 11, while the other channel 44 receives the left hand edge of the right hand solar cell 11, the other edge of which is received in the opposite end cap 41. Flanges 47 and 48 extend rearwardly from the end cap 41 and central cap 43 respectively to stiffen the frame 12. They can also receive tie rods to hold the frame together. A rearwardly extending channel 49 clips onto the adjacent side panel 17.

The frame 12 for the central solar cells 11 is finished by an upper trim 45 and a lower trim 46 which have similar shapes to the rear trim 39 shown in FIG. 5.

One or more of the trims 45, 46 can be removed to allow the central solar cells 11 to be replaced.

1. A solar electrical generator comprising an outer wall defining an open top central cavity;
the outer wall comprising an open frame comprising a plurality of curved members formed with curved channels, the members being arranged such that the curved channels on adjacent members face one another; and
a plurality of flexible solar panels sized such that a respective solar panel can be slid into place in the frame between facing curved channels and supported by the adjacent curved channels.

2. A solar electrical generator according to claim 1, wherein each member has a pair of channels to support back to back flexible solar panels.

3. A solar electrical generator according to claim 1, wherein the members are arranged substantially horizontally.

4. A solar electrical generator according to claim 1, further comprising a plurality of vertical support struts extending vertically along the outer wall.

5. A solar electrical generator according to claim 1, wherein the curved members comprise an upper cap, a base and at least one rail between the cap and base.

6. A solar electrical generator according to claim 1, further comprising an open gap formed in the outer wall on one side of the cavity.

7. A solar electrical generator according to claim 6, wherein the maximum width of the gap is at 10% and preferably at least 20% of the maximum width of the outer wall.

8. A solar electrical generator according to claim 6, further comprising a central solar cell in the cavity positioned so that the central solar cell faces the gap, the central solar cell comprising a further open frame formed of a further plurality of members formed with channels, the further members being arranged such that the channels on adjacent members face one another; and
a further plurality of flexible solar panels sized such that a respective further solar panel can be slid into place in the further frame between adjacent channels and supported by the adjacent channels.

9. A solar electrical generator according to claim 8, wherein the central solar cell has a lower end adjacent to the gap and an upper end on the opposite side of the cavity from the gap.

10. A solar electrical generator according to claim 8, wherein the central solar cell is concave.

11. A solar electrical generator according to claim 8, wherein the upper end of the central solar cell is connected to the outer wall to create a covered space between the solar cell and the outer wall.

12. A solar electrical generator according to claim 11, wherein side panels are provided between the outer wall and the central solar cell to create a closed cavity beneath the outer wall and the central solar cell.

13. A solar electrical generator according to claim 1, wherein the flexible solar panels comprise a thin film organic photovoltaic (OPV) material.

14. A solar electrical generator according to claim 1, further comprising an end cap removably attached to the ends of the channels on adjacent members to support the end of a solar panel between the adjacent channels.

15. A solar electrical generator according to claim 1, wherein the members are formed as extrusions.

16. A solar electrical generator according to claim 1, wherein the further members are formed as extrusions.

17. A solar electrical generator comprising an outer wall defining an open top central cavity;
the solar cells at least partially covering the outer wall;
an open gap formed in the side wall on one side of the cavity;
a central solar cell in the cavity having a lower end adjacent to the gap and an upper end on the opposite side of the cavity from the gap, so that the central solar cell faces the gap,
wherein the upper end of the central solar cell is connected to the outer wall to create a covered space between the solar cell and the outer wall.

18. A solar electrical generator according to claim 17, wherein side panels are provided between the outer wall and the central solar cell to create a closed cavity beneath the outer wall and the central solar cell.
